(19) United States
(12) Patent Application Publication
(10) Pub. No.: US 2024/0402675 A1
(43) Pub. Date: Dec. 5, 2024

(54) SIMULATION DEVICE AND COMPUTER-READABLE RECORDING MEDIUM

(71) Applicant: FANUC CORPORATION, Yamanashi (JP)

(72) Inventor: Hiroaki HADA, Yamanashi (JP)

(21) Appl. No.: 18/695,360

(22) PCT Filed: Oct. 13, 2021
(86) PCT No.: PCT/JP2021/037944

§ 371 Date: Mar. 26, 2024

(51) Int. Cl. G05B 19/4069

(52) U.S. Cl. CPC G05B 19/4069; G05B 2219/35145

(57) ABSTRACT

Provided is a simulation device for simulating machining of a machine tool, the simulation device being configured to calculate a designable range of a voxel size on the basis of workpiece shape data, present the designable range of the voxel size to a user, receive designation of the voxel size, and create an image, in which machining of the machine tool is simulated, on the basis of the designated voxel size.

### TECHNICAL FIELD

The present invention relates to a simulation device and a computer-readable recording medium.

### BACKGROUND ART

Conventionally, there is a technology to create a simulation image by using a movement command from a numerical controller to a machine tool and feedback data from a servomotor to the numerical controller. The simulation image shows an actual state of a machined surface. A high-definition simulation presents irregularities in a few micrometers.

In three-dimensional computer graphics, for example, a workpiece or a tool is represented by a set of three-dimensional cubs called voxels. The size of a voxel is related to display accuracy, and the number of voxels is related to a display time. With reference to FIG. 9, the relationship between the display accuracy and the display time will be described. FIG. 9 shows a three-dimensional image bidimensionally for illustration.

In FIG. 9, the size of the voxel in the left figure is smaller than the size of the voxel in the right figure. The figure shows a tool path that is a range of machining conducted by the tool, and the area adjacent to the tool path is an error on the display. If the size of the voxel is small, the area of the error is small and thus accuracy is high. On the other hand, computation time and drawing time are long because the number of voxels is large.

If the size of the voxel is large, the area of the error is large and the accuracy is low. However, the calculation time and the drawing time are short because the number of voxels is small.

Conventionally, for shortening the display time while increasing the display accuracy, there is a technique of “detecting voxels with which a tool comes into contact and dividing these voxels, so that the number of the divided voxels can be kept to the minimum necessary number to thereby reduce the amount of arithmetic processing”. For example, Patent Literature 1 discloses a reference technique.

### PRIOR ART DOCUMENT

### Patent Literature

[Patent Literature 1] Japanese Patent Laid-Open Publication No. 2008-287456

### SUMMARY OF THE INVENTION

### Problems to be Solved by the Invention

In the field of machine tool simulation, there is a demand of a technology to improve the display accuracy while shortening the time required for display.

### Means for Solving the Problem

An aspect of the present disclosure is a simulation device that simulates machining by a machine tool, including: a voxel size calculation unit that calculates a designable range of a voxel size based on workpiece shape data; a voxel size designation acceptance unit that presents the designable range of the voxel size to a user and accepts designation of the voxel size; and a simulation image creation unit that creates a simulation image of the machining by the machine tool based on the voxel size accepted by the voxel size designation acceptance unit.

An aspect of the present disclosure is a recording medium for recording a command that is executed by one or more processors to: calculate a designable range of a voxel size based on workpiece shape data; present a designable range of a voxel size to a user and accept designation of the voxel size; and create a simulation image of machining by a machine tool based on the accepted designated voxel size.

### Effect of the Invention

One aspect of the present invention can improve the display accuracy while shortening the time for display in a simulation.

### BRIEF DESCRIPTION OF THE DRAWINGS

FIG. 1 is a block diagram of a simulation device;

FIG. 2 is an example of an accuracy condition setting screen;

FIG. 3 is an example of the accuracy condition setting screen;

FIG. 4 is an example of a calculation result of a voxel size;

FIG. 5A is an example of a voxel size setting screen;

FIG. 5B is an example of the voxel size setting screen;

FIG. 6 is an example of simulation images of different voxel sizes;

FIG. 7 is a flowchart illustrating an operation of the simulation device;

FIG. 8 is a hardware configuration diagram of the simulation device; and

FIG. 9 is a relationship between the voxel size and display accuracy.

### MODE FOR CARRYING THE INVENTION

A description will now be made about a simulation device 100 according to the present disclosure.

The simulation device 100 of the present disclosure is implemented in information processing equipment that acquires a movement command of a tool of a machine tool and feedback data of a servo, and displays a machining status of the machine tool with a three-dimensional image. The information processing equipment includes, but is not limited to, a numerical controller, a personal computer (PC) and the like.

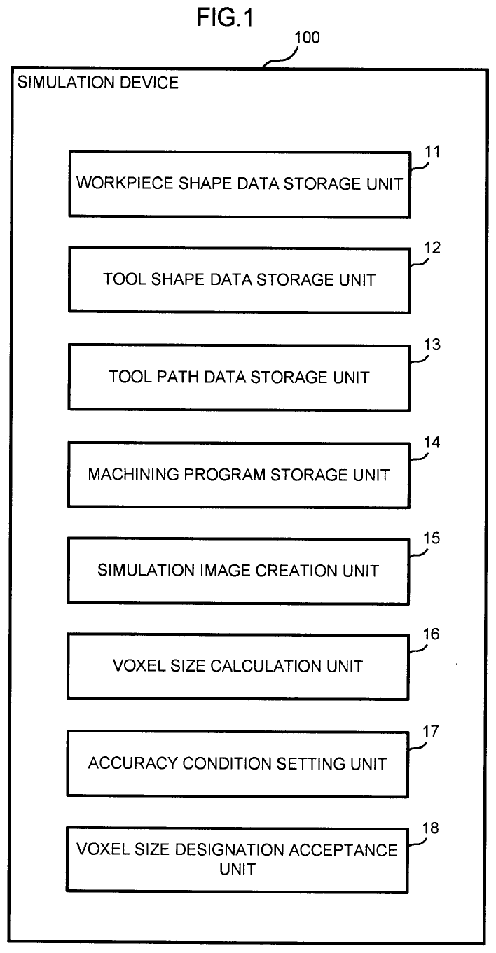

FIG. 1 is a block diagram of the simulation device 100. The simulation device 100 includes a workpiece shape data storage unit 11, a tool shape data storage unit 12, a tool path data storage unit 13, a machining program storage unit 14, a simulation image creation unit 15, a voxel size calculation unit 16, an accuracy condition setting unit 17 and a voxel size designation acceptance unit 18.

The workpiece shape data storage unit 11 is configured to store the shape of a workpiece to be machined by a machine tool. Workpiece shape data bears the size of the workpiece or a value for calculating the size of the workpiece. The tool shape data storage unit 12 is configured to store a tool shape. The size and the type of the tool can be determined based on the tool shape data.

The machining program storage unit 14 is configured to store machining programs of the machine tool. The accuracy of the machining can be known from G-codes written in the machining programs and comments on the programs. For example, roughing has low machining accuracy, whereas precision machining has high machining accuracy. The machining accuracy has effect on the voxel size.

The tool path data storage unit 13 is configured to store a tool path calculated based on the movement command output to the machine tool by the numerical controller or the feedback data from the servo.

The simulation image creation unit 15 is configured to draw three-dimensional images of the workpiece and the tool based on the workpiece shape data and the tool shape data. The simulation image creation unit 15 acquires a stroke of the tool per hour from the tool path data storage unit 13. At this time, a tool posture with respect to the workpiece may be acquired.

The simulation image creation unit 15 calculates interference between the tool and the workpiece based on the tool path and the tool posture. In a case where the tool interferes with the workpiece represented by the voxels, the voxels that are partially or completely inside the tool are removed to simulate changes in the workpiece shape during machining.

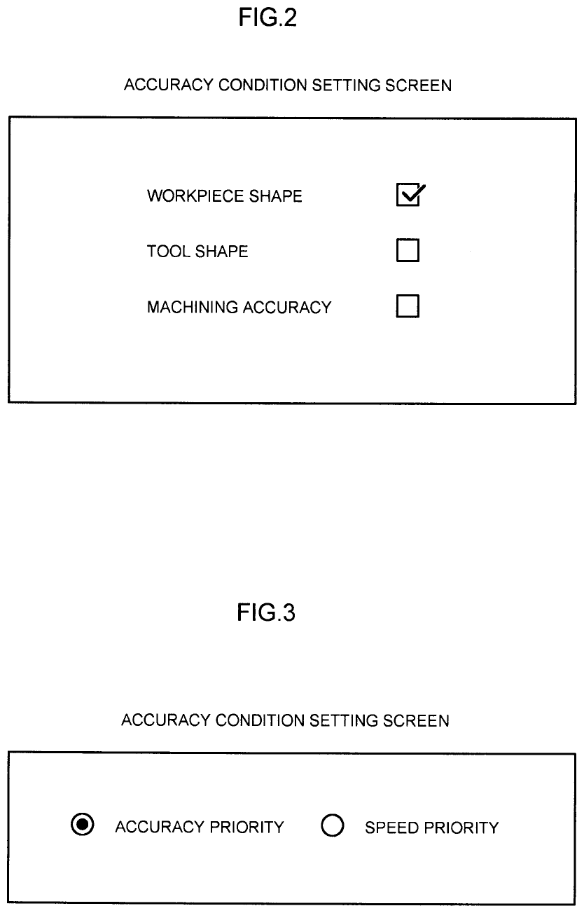

The accuracy condition setting unit 17 is configured to accept a setting of accuracy conditions, which are voxel size calculation conditions, from a user. FIG. 2 is an example of an accuracy condition setting screen. The accuracy condition setting screen allows the user to select at least one of the workpiece shape, the tool shape and the type of machining. In a case of selecting the workpiece shape, the range of the voxel size is calculated based on the size of the workpiece. In a case of calculating the tool shape, the range of the voxel size is calculated based on the tool shape and the type of the tool. In a case of selecting the machining accuracy, the range of the voxel size is calculated based on the machining accuracy.

The accuracy condition setting screen allows the user to set two conditions, such as the workpiece shape and the tool shape, the tool shape and the machining accuracy, or the machining accuracy and the workpiece shape. Furthermore, three conditions of the workpiece shape, the tool shape and the machining accuracy can also be set.

The accuracy condition setting unit 17 may set accuracy priority or speed priority as a user's priority condition. FIG. 3 is another example of the accuracy condition setting screen. The accuracy condition setting screen in FIG. 3 allows the user to set either the accuracy priority or the speed priority.

The voxel size calculation unit 16 is configured to calculate a voxel size designable range based on the accuracy conditions. The voxel size designable range means a range of the voxel size that the user can designate.

In a case where the workpiece shape is set as an accuracy condition, the voxel size calculation unit 16 reads, for instance, the size of the workpiece from the workpiece shape data storage unit 11. The size of the workpiece may be calculated based on the workpiece shape. The voxel size calculation unit 16 calculates the voxel size range which is designable by the user based on the size of the workpiece, an amount of memory used for the simulation and a calculated load.

More specifically, the voxel size is related to the size of the workpiece. The larger the workpiece size is, the larger the voxel size can be. The number of the voxels is limited in accordance with hardware resources, such as the amount of memory used for the simulation. The voxel size calculation unit 16 calculates the range of the voxel size that does not exceed the limit on the number of the voxels and satisfies the accuracy condition and the priority condition.

When the tool shape is set as an accuracy condition, the voxel size suitable for the size of the tool and the type of the tool is calculated. In a case where the tool is large, the voxel size may be large because the machining accuracy is not high. In a case where the tool is small or a tool with high machining accuracy is used, the voxel size should be small because the machining accuracy is high. More specifically, the voxels may be large if the type of the tool is for roughing, whereas the smaller voxels are suitable if the type of the tool is for finishing.

When the machining accuracy is set as an accuracy condition, a determination is made on the machining accuracy to calculate the voxel size according to the machining accuracy. The determination on the machining accuracy is made by the machining program, by way of example. That is, the machining accuracy is determined from the G-codes of the machining program and the program comments. In a case where the machining conditions are set when the machining accuracy is low as in the roughing or where the program comments state that the machining is for roughing, the voxels may be large. In a case where the machining conditions are set when the machining accuracy is high as in the finishing or the precision machining or where the program comments state that the machining is for finishing or precision machining, smaller voxels are suitable.

The voxel size also differs depends on the user's priority conditions. When the user sets the accuracy priority, the voxel size is small, and when the user sets the speed priority, the voxel size is large.

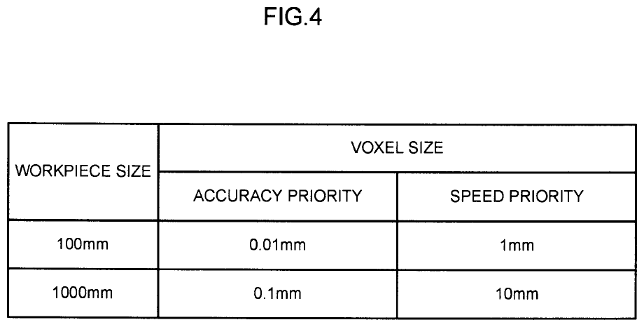

FIG. 4 is an example of a calculation result of the voxel size. This example shows a case where the workpiece shape is set as an accuracy condition and the accuracy priority is set as a priority condition. If the size of the workpiece is 100 mm, the voxel size in the case of the accuracy priority is 0.01 mm, and the voxel size in the case of the speed priority is 1 mm. If the size of the workpiece is 1000 mm, the voxel size in the case of the accuracy priority is 0.1 mm, and the voxel size in the case of the speed priority is 10 mm.

The larger the size of the workpiece is, the larger the voxel size is. The voxel size is smaller in the case of the accuracy priority, and the voxel size is larger in the case of the speed priority.

When the tool shape and the machining accuracy are set as accuracy conditions, the voxel size suitable for the set conditions is calculated.

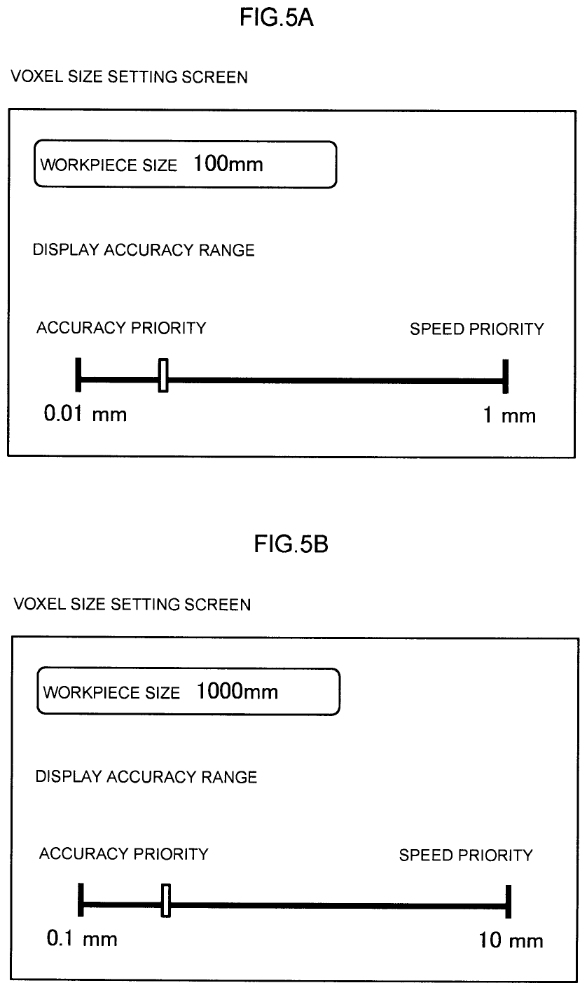

The voxel size designation acceptance unit 18 is configured to display a range of the voxel size and accept the designation of voxel size. FIGS. 5A and 5B are examples of a voxel size designation screen. These screens are voxel size acceptance screens when the workpiece shape is selected as the accuracy condition. FIG. 5A is a voxel size designation screen when the size of the workpiece is 100 mm, in which case a voxel size in a range between the accuracy priority (0.01 mm) and the speed priority (1 mm) is accepted. FIG. 5B is a voxel size designation screen when the size of the workpiece is 1000 mm, in which case a voxel size in a range between the accuracy priority (0.1 mm) and the speed priority (10 mm) is accepted.

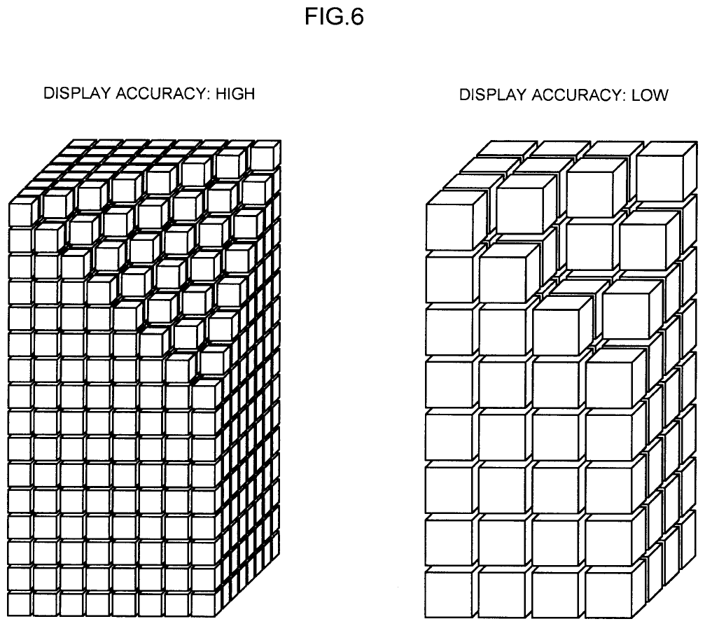

The simulation image creation unit 15 is configured to create a simulation image based on a voxel size calculated by the voxel size calculation unit 16 or a voxel size accepted in the voxel size designation acceptance unit 18. FIG. 6 shows a simulation image with high display accuracy on the left and a simulation image with low display accuracy on the right. The small voxel size has an advantage that the display accuracy is high. There are disadvantages that a calculation time for clipping off voxels is long and a time for drawing voxels is long because the number of the voxels is large. The large voxel size has advantages that the calculation time for clipping off the voxels is short and the time for drawing the voxels is short. There is a disadvantage that the display accuracy is low.

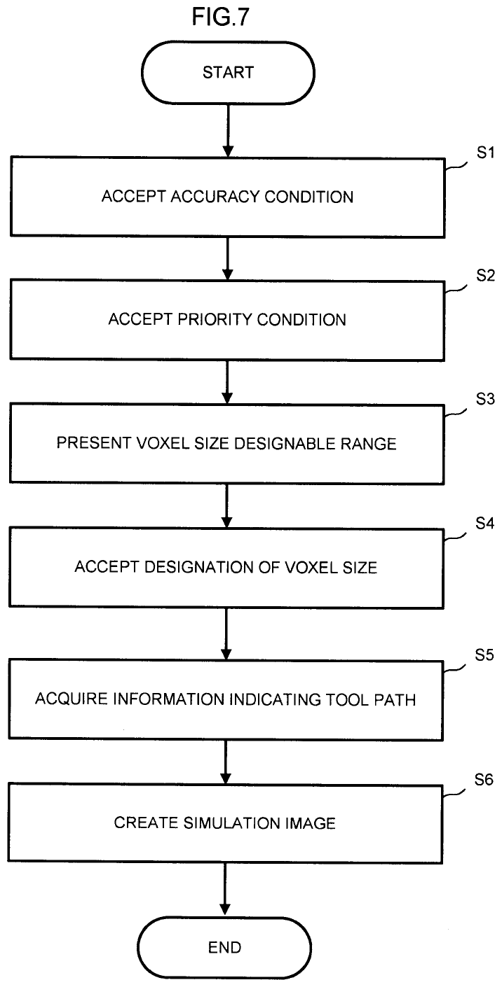

With reference to FIG. 7, a description will be made about an operation of the simulation device 100 of the present disclosure.

The simulation device 100 accepts an accuracy condition (step S1). As the accuracy condition, at least one of the workpiece shape, the tool shape and the type of machining, is accepted. The accuracy condition may be set by the simulation device 100 rather than by a user.

The simulation device 100 accepts a priority condition (step S2). The priority condition includes, for example, accuracy priority and speed priority.

The simulation device 100 calculates a range of the voxel size based on the accuracy conditions and the priority conditions (step S3). The simulation device 100 presents the range of the voxel size to the user to thereby accept designation of the voxel size (step S4).

When the voxel size is designated, the simulation device 100 acquires information indicating a tool path, such as a movement command of a tool of a machine tool from the numerical controller or feedback data from a servo (step S5). The movement command of the tool or the feedback data from the servo may be read from the tool path data storage unit 13 instead of being obtained in real time.

The simulation device 100 determines interference between the tool and a workpiece based on the movement command of the tool or the feedback data from the servo. When the tool interferes with the workpiece represented by the voxels, the simulation device 100 removes the voxels that exist inside the tool, and simulates the change in the workpiece shape during machining to thereby create a simulation image (step S6). Since the voxel size is set to an appropriate size according to the workpiece shape, the tool shape, the type of machining and the user's priority conditions, the simulation image can be created with the accuracy or speed desired by the user.

As described above, the simulation device 100 of the present disclosure automatically calculates the voxel size range designable by the user based on, such as, the workpiece shape, the tool shape and the machining accuracy. The user designates the priority conditions and others so that the suitable voxel size can be designated within the calculated designable range. Consequently, the simulation image can be created with the accuracy and the speed suitable for the user's purpose.

The accuracy conditions may be any of the workpiece shape, the tool shape and the machining accuracy, or may be a combination of them. The voxel size can also be adjusted depending on whether the user put a priority on the accuracy or the speed.

The present disclosure may combine another display accuracy increasing means and drawing device improving means. For example, the present disclosure may apply a small voxel size to a workpiece surface to increase the display accuracy and the drawing speed.

### [Hardware Configuration]

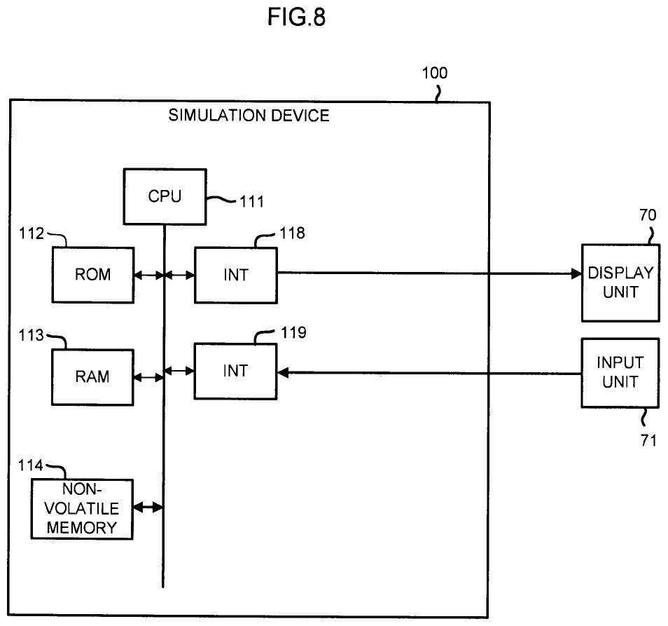

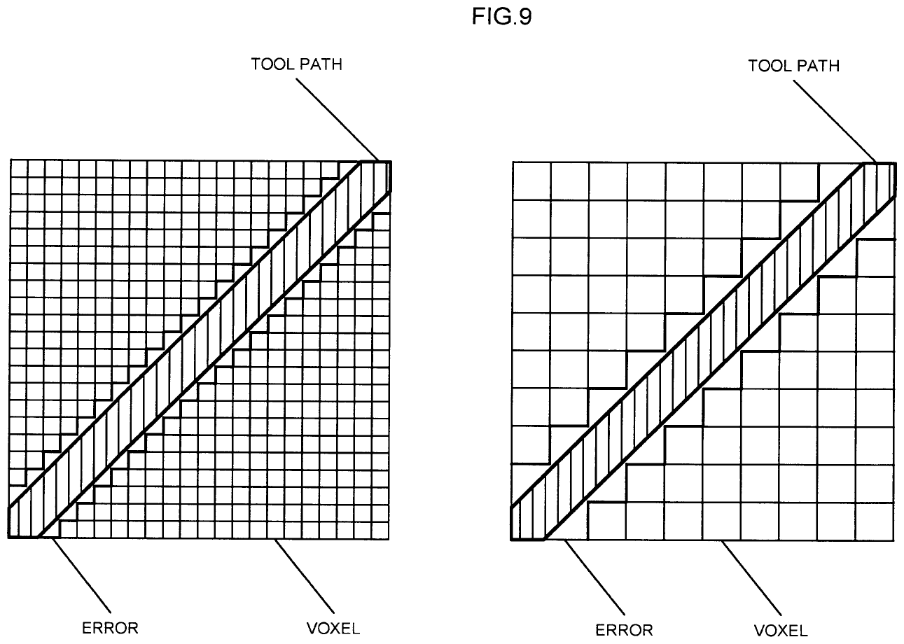

A hardware configuration of the simulation device 100 will be described with reference to FIG. 8. The simulation device 100 includes a CPU 111 that is a processor for controlling the entire simulation device 100. The CPU 111 is configured to read a system program processed by a ROM 112 through a bus to thereby control the entire simulation device 100 in accordance with the system program. A RAM 113 is configured to temporarily store temporary computation data and pieces of data to be displayed, as well as various data input by a user through an input unit 71.

A display unit 70 is a monitor or similar that is attached to the simulation device 100. The display unit 70 is configured to display an operation screen, a setting screen, and the like of the simulation device 100.

The input unit 71 is a keyboard, touch panel or similar that is integral with or separate from the display unit 70. The user operates the input unit 71 to input data to a screen displayed by the display unit 70, for instance. The display unit 70 and the input unit 71 may be mobile devices.

A non-volatile memory 114 is, for example, a memory that is backed up by a battery, not shown, so that a state of storage is retained even when a power source of the simulation device 100 is turned off. The non-volatile memory 114 is configured to store workpiece shape data, tool shape data, tool path data and machining programs. The non-volatile memory 114 stores programs read from an external device via an interface, not shown, programs input through the input device 71, and various data acquired from the units of the simulation device 100, the machine tool and others (e.g., setting parameters acquired from the machine tool). The programs and the various data stored in the non-volatile memory 114 may be loaded into the RAM 113 when they are executed/used. Furthermore, the ROM 112 is configured to store various system programs in advance.

### REFERENCE SIGNS LIST

### 100 Simulation Device

### 11 Workpiece Shape Data Storage Unit

### 12 Tool Shape Data Storage Unit

### 13 Tool Path Data Storage Unit

### 14 Machining Program Storage Unit

### 15 Simulation Image Creation Unit

### 16 Voxel Size Calculation Unit

### 17 Accuracy Condition Setting Unit

### 18 Voxel Size Designation Acceptance Unit

### 70 Display Unit

### 71 Input Unit

### 111 CPU

### 112 ROM

### 113 RAM

### 114 Non-Volatile Memory

1. A simulation device for simulating machining by a machine tool, comprising:
a voxel size calculation unit that calculates a voxel size designable range based on workpiece shape data;
a voxel size designation acceptance unit that presents the voxel size designable range to a user and accepts designation of the voxel size; and
a simulation image creation unit that creates a simulation image of the machining by the machine tool based on the voxel size accepted by the voxel size designation acceptance unit.

2. The simulation device according to claim 1, wherein the voxel size calculation unit calculates the voxel size designable range based on tool shape data, in addition to the workpiece shape data.

3. The simulation device according to claim 2, wherein the tool shape data includes at least one of tool size or tool type.

4. The simulation device according to claim 1, wherein the voxel size calculation unit calculates the voxel size designable range based on machining accuracy, in addition to the workpiece shape data.

5. The simulation device according to claim 1, comprising an accuracy condition setting unit that accepts a user's priority condition, wherein
the voxel size designable range is presented associated with the priority condition.

6. A recording medium for recording commands which are readable by one or more processors, the one or more processors conducting the commands to:
calculate a voxel size designable range based on workpiece shape data;
present the voxel size designable range to a user and accept designation of the voxel size; and
create a simulation image of machining by a machine tool based on the accepted designated voxel size.
